(19) United States
(12) Patent Application Publication
(10) Pub. No.: US 2016/0068007 A1
(43) Pub. Date: Mar. 10, 2016

(54) ERASABLE PAD FOR THE MARKING OF CONSTRUCTION MEASUREMENTS

(71) Applicant: Sean Burton, Johnstown, OH (US)

(72) Inventor: Sean Burton, Johnstown, OH (US)

(21) Appl. No.: 14/480,376

(22) Filed: Sep. 8, 2014

(51) Int. Cl. B43L 1/00

(52) U.S. Cl. CPC B43L 1/00

(57) ABSTRACT

This device is an erasable tab that can be attached a to a belt or the craftsperson's clothing or equipment. It is designed to be light weight and flexible. The erasable tab consists for a base with an attachment means and a pad which is connected to the base by a connection means. The pad can be written on and is erasable by a simple thumb wipe.

### STATEMENT AS TO RIGHTS TO INVENTIONS MADE UNDER FEDERALLY SPONSORED RESEARCH AND DEVELOPMENT

None

### FIELD OF THE INVENTION

This device refers to the field of an erasable pad to write on; more specifically one that can easily be used in construction.

### BACKGROUND OF THE INVENTION

During constructions of a building or during any construction project, craftspersons, such as carpenters and plumbers, always need to mark down measurements and similar data so that they have a quick reference for the next cutting or placing of construction material. Currently many craftspersons just mark with a writing tool such as a pencil on scrap wood or any such material that they can get their hands on at the construction site. The problem is that this material can be misplaced or thrown away or can even be non-legible when the craftsperson needs.

There exists a need for a tool or device on which a craftsperson can mark measurements and notes on that is easy to use, safe, easy to find and reusable.

There remains room for improvement in the current device.

### SUMMARY OF THE INVENTION

This proposed device is an erasable pad to be used mark down measurements and notes while working

The current invention is an erasable tab that can be attached a to a belt or the craftsperson's clothing or equipment. It is designed to be light weight and flexible.

It is made up a base with loop openings that allows it to be connected to a belt and a pad which is connected to the base by a connection means which can be metal studs or glue or another means. The pad is erasable by a simple thumb wipe.

The device would be available in many sizes identified by size of the pad.

### BRIEF DESCRIPTION OF DRAWINGS

Without restricting the full scope of this invention, the preferred form of this invention is illustrated in the following drawings in which:

FIG. 1 is a front view of the device;

FIG. 2 is a back view of the device;

FIG. 3 is a side view of the device;

FIG. 4 shows a front view of the device being used;

FIG. 5 shows how simply the pad is erased; and

FIG. 6 shows an alternative embodiment with a pin attachment.

### DETAILED DESCRIPTION OF THE PREFERRED EMBODIMENT

There are a number of significant design features and improvements incorporated within the invention.

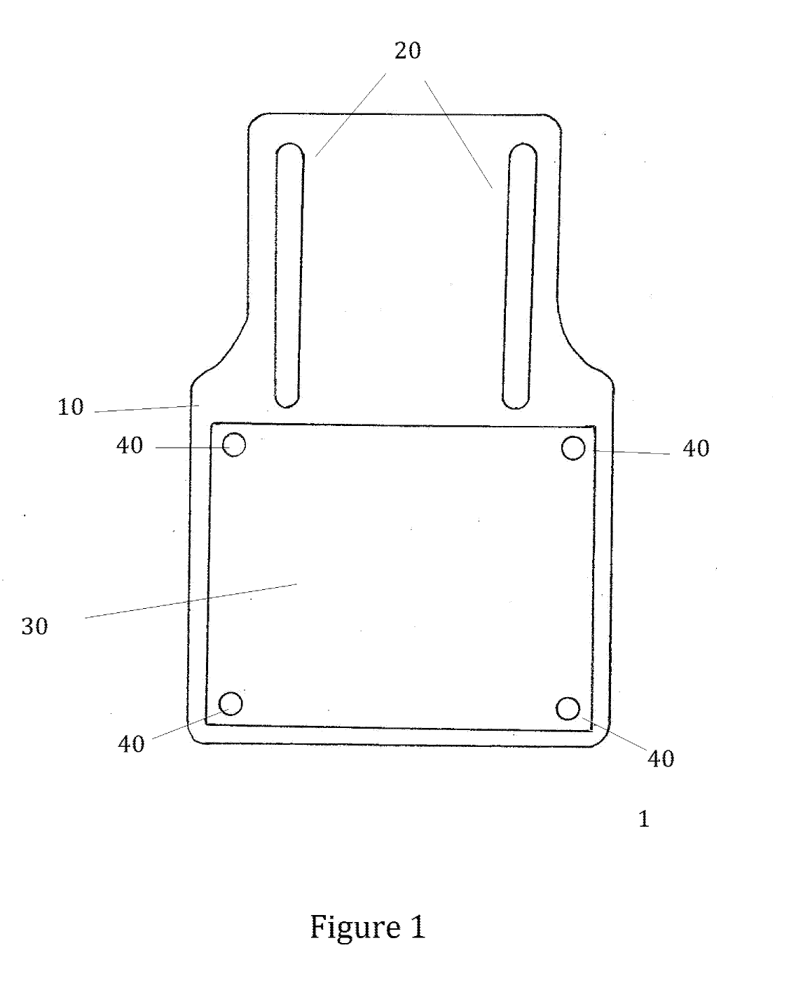

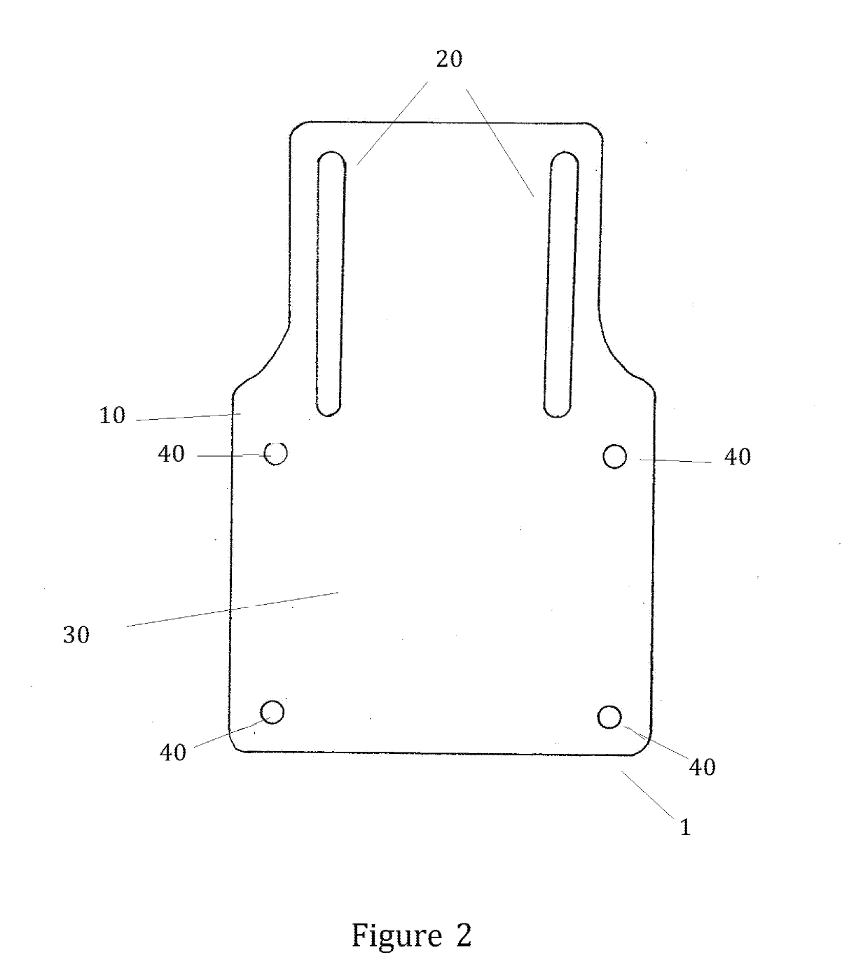

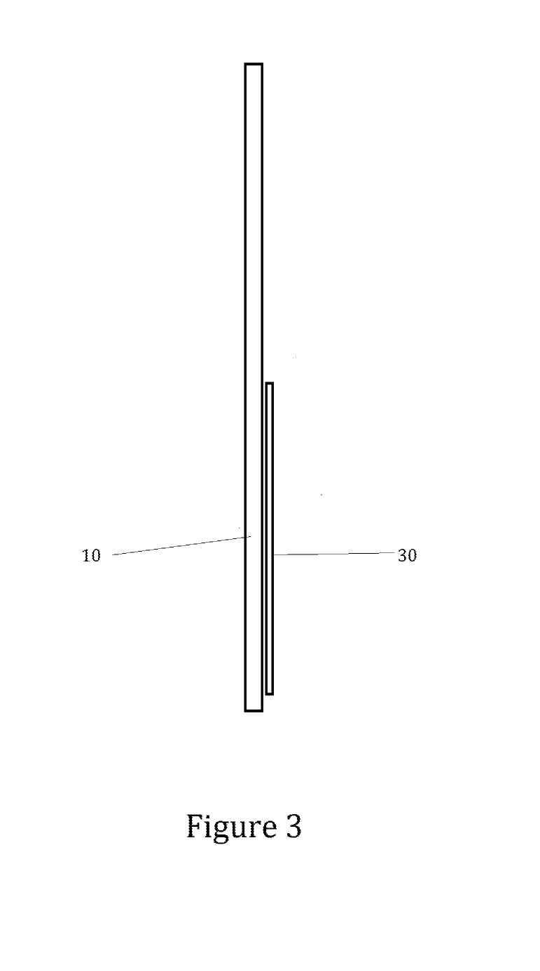

The current invention is an erasable pad 1 that can be attached a to a belt or the craftsperson's clothing or equipment. As shown in FIG. 1 through 3, it is designed to be easy to use and of a flexible material without hard edges for safety.

It is made up a base 10. The base 10 has a wide bottom that tapers to a narrower top. The base 10 would be made of a light weight flexible material which in the preferred embodiment would be leather or rubber.

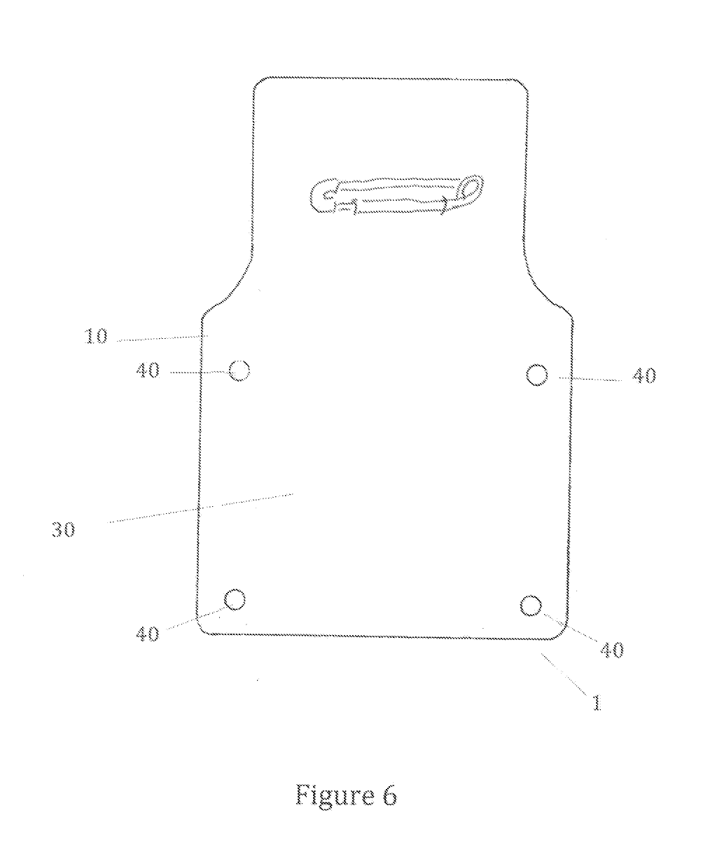

In the preferred embodiment, the top has loop openings 20 that allow it to be connected to a belt. In alternative embodiments, the erasable pad 1 can be attached through any convenient attachment means such an attached safety pin means as shown in FIG. 6 allowing the user to place it other locations besides the belt. In the preferred embodiment, the attachment means is connected to the top part of the base 10 so that the bottom of the base 10 can be moved when the user can see it better.

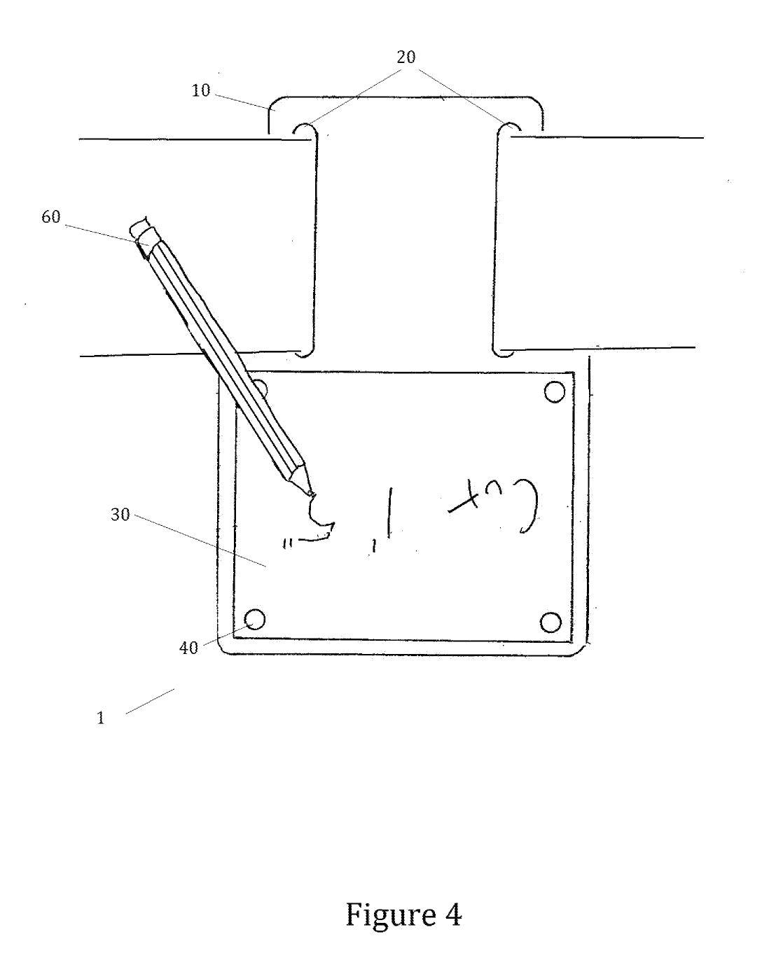

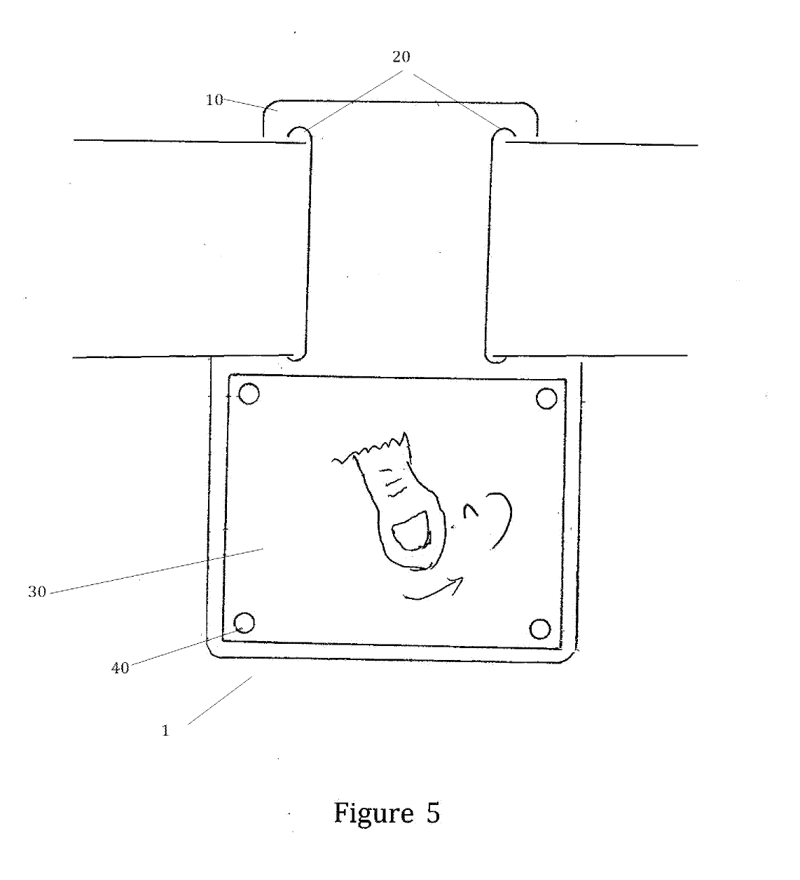

A pad 30 is connected to the bottom of the base 10. The pad 30 is connected to the base 10 by a connection means which can be metal studs 40 or glue or another means that can connect the pad 30 securely to the base 10 while being light weight. The pad 30 has a front surface that can be marked on and is made of an erasable material such as a white polyurethane. In the preferred embodiment, the front surface of the pad 30 is white or another light color. The user writes the information that they want to remember such as measurement s on the pad 30 as shown in FIG. 4 and the design of the pad 30 allows the pad to be erased by a simple thumb wipe as shown in FIG. 5. The user can use a pencil 60 or erasable marker.

As shown in FIG. 6, the base 10 is flexible and can bend between the attachment means on the top portion and the pad 30 on the bottom portion. This allows the user position the pad so that it is easier for the user to see what has been written.

The device would be available in many sizes identified by size of the pad 30. The pad 30 is rectangular in the preferred embodiment but can be any size and shape. In an alternative embodiment the upper and lower sections of the base 10 can be the same size or the upper section can be larger.

It is designed to be light weight and flexible. The erasable pad 1 will not have any hard surfaces in addition to being flexible. This is the make the erasable pad 1 to be safe to use as a worksite.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

1-20. (canceled)

21. A device comprising:
A flexible base having a top portion and a front bottom portion with an attachment means on the top portion and a pad on the front bottom portion where said pad is has a front surface that is made of a markable and erasable material where the base has a wider bottom that tapers to a narrower top where the pad is white in color where the pad is connected through a connection means.

22. A device according to claim 21 further comprising:
where the bottom of the base is moveable.

23. A device according to claim 21 further comprising:
where the top has a plurality of loop openings.

24. A device according to claim 21 further comprising:
where the attachment means is a safety pin.

26. A device according to claim 21 further comprising:
where the connection means is metal studs.

27. A device according to claim 21 further comprising:
where the connection means is glue.
